(19) United States
(12) Patent Application Publication
(10) Pub. No.: US 2011/0125572 A1
(43) Pub. Date: May 26, 2011

(54) OPTIMIZATION OF SPONSORED SEARCH SYSTEMS WITH REAL-TIME USER FEEDBACK

(75) Inventors: Erick Cantu-Paz, Sunnyvale, CA (US); Eren Manavoglu, Menlo Park, CA (US)

(73) Assignee: YAHOO! INC., Sunnyvale, CA (US)

(21) Appl. No.: 12/626,462

(22) Filed: Nov. 25, 2009

(51) Int. Cl. G06Q 30/00; G06F 17/30; G06Q 10/00

(52) U.S. Cl. 705/14.43; 705/14.44; 705/14.45; 705/14.46; 707/713; 707/E17.017

(57) ABSTRACT

Search and advertising systems may be optimized through the use of user feedback. Selected parameters such as ranking, filtering, placement, and pricing may be optimized to achieve certain objectives. The optimization may include real-time user monitoring of multiple configurations with various parameters. In one embodiment, a subset of user queries may be assigned to a particular configuration for monitoring and measuring the real-time performance of that configuration. The performance for multiple configurations may be used to identify optimal settings.

### BACKGROUND

Online advertising may be an important source of revenue for enterprises engaged in electronic commerce. Processes associated with technologies such as Hypertext Markup Language (HTML) and Hypertext Transfer Protocol (HTTP) enable a web page to be configured to display advertisements. Advertisements may commonly be found on many web sites. For example, advertisements may be displayed on search web sites and may be targeted to individuals based upon search terms provided by the individuals.

As the Internet has grown, the number of web sites available for hosting advertisements has increased, as well as the diversity among web sites. In other words, the number of web sites focusing on selective groups of individuals has increased. As a result of this increase, it has become increasingly difficult for advertisers to optimize the targeting of their advertisements. Advertisers may be unfamiliar with the most effective ways to target their advertisements on websites and in sponsored searching. This may result in a lower rate of return for the advertiser. That advertiser may have received a greater rate of return had the advertiser targeted his advertisement more effectively.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is a diagram of an exemplary network system;

FIG. 2 is a diagram of an alternative exemplary network system;

FIG. 3 is a diagram of an exemplary optimizer;

FIG. 4 is a diagram of exemplary optimization;

FIG. 5 is a diagram of exemplary objectives for optimization;

FIG. 6 is a diagram of exemplary configuration parameters; and

FIG. 7 is flowchart of exemplary optimization.

### DETAILED DESCRIPTION

By way of introduction, search and advertising systems may be optimized through the use of real-time user feedback. Selected parameters such as ranking, filtering, placement, and pricing may be optimized to achieve certain objectives. The system's optimization may include real-time user monitoring of different configurations with differing parameters as discussed below. In one embodiment, a slice or subset of user queries may be assigned to a particular configuration for monitoring and measuring the real-time performance and results of that configuration. The performance and results for multiple configurations may be used to identify optimal settings from those configurations.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below.

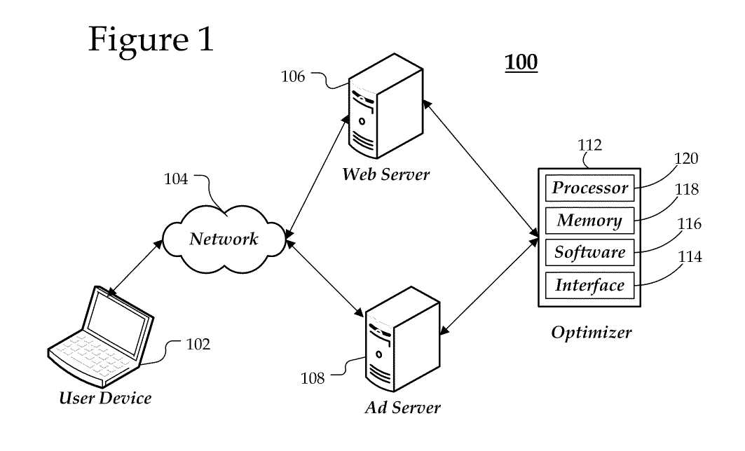

FIG. 1 depicts a block diagram illustrating one embodiment of an exemplary network system 100. The network system 100 may provide a platform for the optimization of ads. In the network system 100, a user device 102 is coupled with a web server 106 and an advertisement (“ad”) server 108 through a network 104. An optimizer 112 may be coupled with the web server 106 and the ad server 108. Herein, the phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The user device 102 may be a computing device which allows a user to connect to a network 104, such as the Internet. Examples of a user device include, but are not limited to, a personal computer, personal digital assistant (“PDA”), cellular phone, or other electronic device. The user device 102 may be configured to allow a user to interact with the web server 106, the ad server 108, or other components of the network system 100. The user device 102 may include a keyboard, keypad or a cursor control device, such as a mouse, or a joystick, touch screen display, remote control or any other device operative to allow a user to interact with the web server 106 via the user device 102. In one embodiment, the user device 102 is configured to request and receive information from the web server 106, and/or the ad server 108. The web server 106 may be a search engine that provides a web page and search results, and the ad server 108 may provide advertisements for the web page, such as during sponsored searching. The user device 102 may be configured to access other data/information in addition to web pages over the network 104 using a web browser, such as INTERNET EXPLORER® (sold by Microsoft Corp., Redmond, Wash.) or FIREFOX® (provided by Mozilla). The data displayed by the browser may include advertisements. In an alternative embodiment, software programs other than web browsers may also display advertisements received over the network 104 or from a different source.

The web server 106 may act as an interface through the network 104 for providing a web page to the user device 102. In one embodiment, the web server 106 comprises a search engine, and the web page that is provided to the user device 102 may be a search results page. The web server 106 may provide the user device 102 with any pages that include advertisements and that are requested by a user of the user device 102. In alternative embodiments, there may be a search engine that is separate from the web server 106. In one example, the web server 106 may receive requests from the user device 102 and route data from the search engine and/or the ad server 108 for display back on the user device 102.

The web server 106 may provide a web page, or a series of web pages, when requested from the user device 102. In one example, the web server 106 is coupled with or includes a search engine, and the request from the user device 102 is a search query from a user, and the web page that is provided is a search results page for that query. The search results page may include advertisements based on those search results. In other words, the web server 106 and the ad server 108 provide sponsored search results in one example. In alternative embodiments, the web server 106 may provides pages other than search results pages that also include advertisements or other features that are optimized. As described below, the provided pages may include advertising space or advertisement slots that are filled with advertisements viewed with the page on the user device 102.

In one embodiment, the web server 106 may include or be coupled with a database or storage system that stores information about the pages that are provided to the user device 102. For example, an exemplary database may include records or logs of at least a subset of the requests for data/pages submitted to the web server 106 over a period of time. In one example, the database may include a history of Internet browsing data related to the pages provided by the web server 106. The stored data may relate to or include various user information, such as preferences, interests, profile information or browsing tendencies, and may include the number of impressions and/or number of clicks on particular advertisements.

The ad server 108 may provide advertisements with or as a part of the pages provided to the user device 102. The ad server 108 may provide advertisements to the web server 106 for the page being provided to the user device 102. In one embodiment, the ad server 108 may include or be coupled with an advertiser (“ad”) database that stores advertisements and relevant information for the display of those advertisements. Advertisements, such as images, video, audio, text, banners, flash, animation, or other formats may be stored in the ad database. The ad database may also include records regarding the advertisements that are shown and the resulting impressions, clicks, and/or actions taken for those advertisements. The data related to advertisement impressions, clicks and resulting actions may be stored in either the search engine/web server database and/or an advertiser database. The advertisement (“ad”) data, along with the user profile data, may be used by the optimizer 112 for determining optimal configurations for web pages and for ads on those pages. The data may be continuously updated to reflect current viewing, clicking, and interaction with the advertisements displayed on the user device 102.

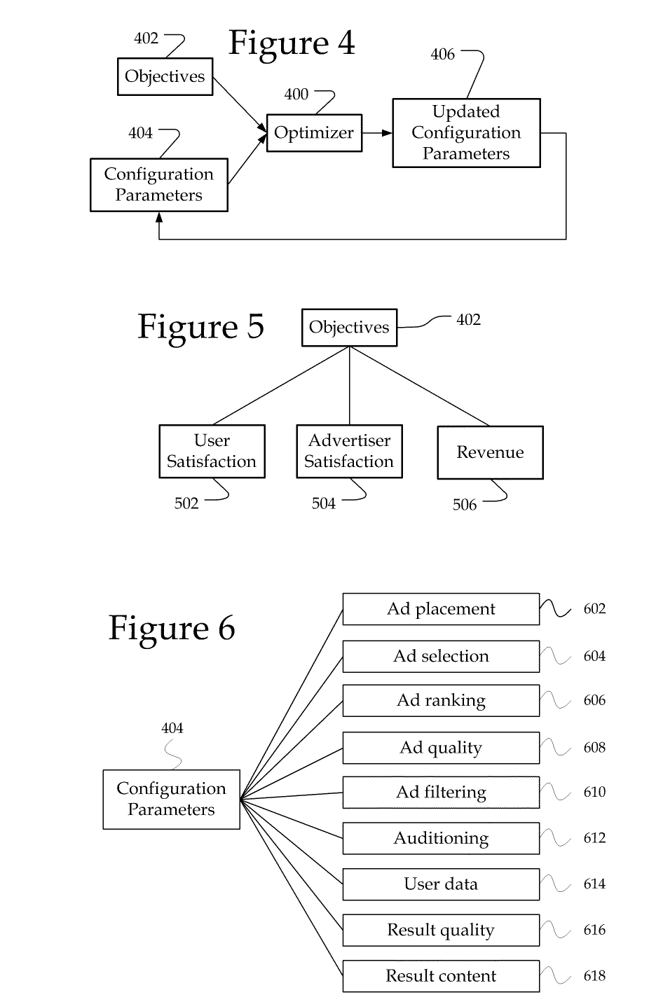

The ad server and/or the web server may utilize configuration parameters that determine how ads are selected and placed on the page as described below. A particular configuration may correspond with one or more configuration parameters that determine how the ads are selected and how those ads are placed or displayed on a particular page. The optimization of configurations and the configuration parameters may refer to an optimal selection and placement of ads on a page. In particular, FIGS. 3-4 illustrate the operation of the optimizer 112 and exemplary configuration parameters. Advertisements and their usage data and performance data may be analyzed by the optimizer 112. The optimizer 112 may be coupled with the web server 106 and the ad server 108 for optimizing the display of ads. In one embodiment, the optimizer 112 may be a part of the web server 106 and/or a part of the ad server 108. The optimizer 112 may analyze ads and users, as well as usage and profile data for both ads and users to identify configurations of ads that are most effective. The optimization is further described below in FIGS. 3-7.

The optimizer 112 may be used by the web server 106 and/or the ad server 108 for identifying more effective ad configurations and configuration parameters that satisfy certain objectives. Exemplary objectives that the optimizer 112 satisfies are illustrated in FIG. 5. In other words, the optimizer 112 identifies configurations and configuration parameters that satisfy or maximize the objectives. The configurations and/or configuration parameters can be iteratively tested to determine and update the optimal configurations.

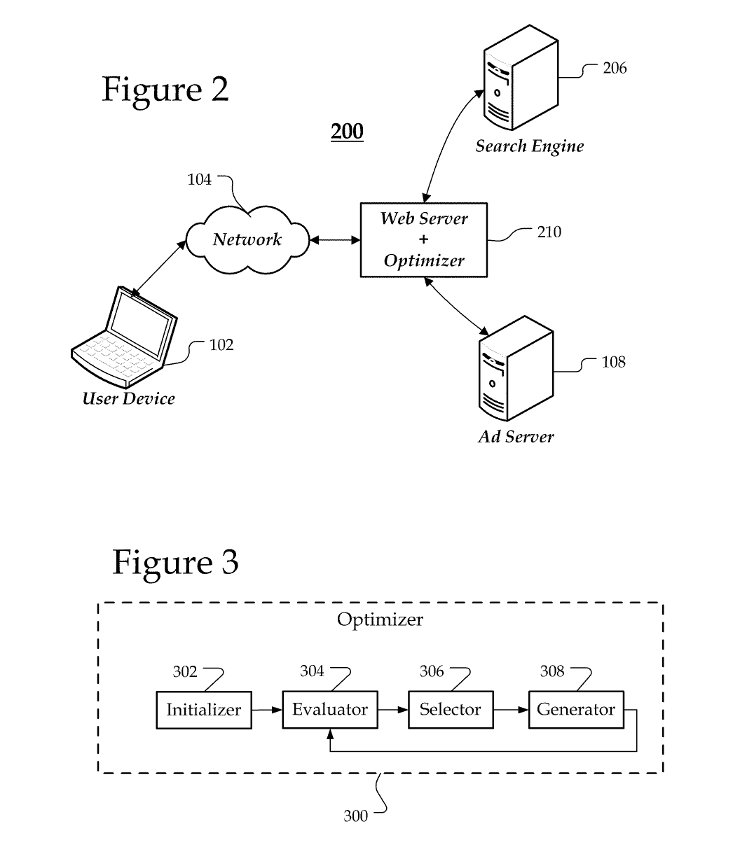

The optimizer 112 may be a computing device for monitoring and analyzing ads and users that identifies optimal configurations of ads. The optimizer 112 may include a processor 120, a memory 118, software 116 and an interface 114. The optimizer 112 may be a separate component from the web server 106 and/or the ad server 108, or they may be combined as a single component or hardware device. Alternatively, as shown in FIG. 2, the optimizer 112 may be combined with a separate web server.

The interface 114 may communicate with any of the user device 102, the web server 106, and/or the ad server 108. The interface 114 may include a user interface configured to allow a user and/or administrator to interact with any of the components of the optimizer 112. For example, the administrator and/or user may be able to review or update the objectives or configuration parameters that are optimized.

The processor 120 in the optimizer 112 may include a central processing unit (CPU), a graphics processing unit (GPU), a digital signal processor (DSP) or other type of processing device. The processor 120 may be a component in any one of a variety of systems. For example, the processor 120 may be part of a standard personal computer or a workstation. The processor 120 may be one or more general processors, digital signal processors, application specific integrated circuits, field programmable gate arrays, servers, networks, digital circuits, analog circuits, combinations thereof, or other now known or later developed devices for analyzing and processing data. The processor 120 may operate in conjunction with a software program, such as code generated manually (i.e., programmed).

The processor 120 may be coupled with the memory 118, or the memory 118 may be a separate component. The software 116 may be stored in the memory 118. The memory 118 may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 118 may include a random access memory for the processor 120. Alternatively, the memory 118 may be separate from the processor 120, such as a cache memory of a processor, the system memory, or other memory. The memory 118 may be an external storage device or database for storing recorded ad or user data. Examples include a hard drive, compact disc (“CD”), digital video disc (“DVD”), memory card, memory stick, floppy disc, universal serial bus (“USB”) memory device, or any other device operative to store ad or user data. The memory 118 is operable to store instructions executable by the processor 120.

The functions, acts or tasks illustrated in the figures or described herein may be performed by the programmed processor executing the instructions stored in the memory 118. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 120 is configured to execute the software 116.

The interface 114 may be a user input device or a display. The interface 114 may include a keyboard, keypad or a cursor control device, such as a mouse, or a joystick, touch screen display, remote control or any other device operative to allow a user or administrator to interact with the optimizer 112. The interface 114 may include a display coupled with the processor 120 and configured to display an output from the processor 120. The display may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor 120, or as an interface with the software 116 for providing input parameters. In particular, the interface 114 may allow a user to interact with the optimizer 112 to view or modify the objectives and/or configuration parameters.

The present disclosure contemplates a computer-readable medium that includes instructions or receives and executes instructions responsive to a propagated signal, so that a device connected to a network can communicate voice, video, audio, images or any other data over a network. The interface 114 may be used to provide the instructions over the network via a communication port. The communication port may be created in software or may be a physical connection in hardware. The communication port may be configured to connect with a network, external media, display, or any other components in system 100, or combinations thereof. The connection with the network may be a physical connection, such as a wired Ethernet connection or may be established wirelessly as discussed below. Likewise, the connections with other components of the system 100 may be physical connections or may be established wirelessly.

Any of the components in the system 100 may be coupled with one another through a network, including but not limited to the network 104. For example, the optimizer 112 may be coupled with the web server 106 and/or the ad server 108 through a network. Accordingly, any of the components in the system 100 may include communication ports configured to connect with a network.

The network or networks that may connect any of the components in the system 100 to enable communication of data between the devices may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or WiMax network. Further, the network(s) may be a public network, such as the Internet, a private network, such as an intranet, or combinations thereof, and may utilize a variety of networking protocols now available or later developed including, but not limited to TCP/IP based networking protocols. The network(s) may include one or more of a local area network (LAN), a wide area network (WAN), a direct connection such as through a Universal Serial Bus (USB) port, and the like, and may include the set of interconnected networks that make up the Internet. The network(s) may include any communication method or employ any form of machine-readable media for communicating information from one device to another. As discussed, the ad server 108 or the web server 106 may provide advertisements and/or content to the user device 102 over a network, such as the network 104.

The web server 106, the optimizer 112, the ad server 108, and/or the user device 102 may represent computing devices of various kinds. Such computing devices may generally include any device that is configured to perform computation and that is capable of sending and receiving data communications by way of one or more wired and/or wireless communication interfaces, such as interface 114. For example, the user device 102 may be configured to execute a browser application that employs HTTP to request information, such as a web page, from the web server 106.

FIG. 2 is a diagram of an alternative exemplary network system 200. The user device 102 is coupled with the network 104. In system 200, the web server 210 may include the optimizer. The search engine 206 and the ad server 108 are coupled with the web server 210. In alternative embodiments, the optimizer may be separate from but coupled with the web server 210. The system 200 illustrates that the data is received from the user device 102 over the network 104 is received at the optimizer before the search engine 206 or the ad server 108. Likewise, the optimizer may receive the messages/data that the search engine 206 and the ad server 108 transmit to the user device 102.

The optimizer may be configured to use real-time user feedback for optimizing certain objectives. The feedback may include user interactions with the web pages and/or the advertisements, such as issuing new queries, or clicking on advertisements or other links on the web page. In the system 200, the feedback may be received directly by the web server 210 and by the corresponding optimizer. As described below, this feedback may be used by the optimizer for modifying adjustable parameters and configurations for determining an optimal configuration based on the parameter adjustments. As described, the optimizer may consider multiple configurations simultaneously and a slice of user queries may be assigned to a particular configuration for monitoring and measuring the real-time performance and results of that configuration. As the performance/results are received, the optimizer may utilize the data for other configurations of search results and/or displayed advertisements.

FIG. 3 is a diagram of an exemplary optimizer 300. The optimizer 300 may utilize an evolutionary multi-objective algorithm for optimizing a set of candidate solutions/configurations. Other optimization algorithms, such as simulated annealing, grid search, pattern search, can be used. If the optimizer utilizes an evolutionary algorithm, one embodiment of the optimizer 300 may include an initializer 302, an evaluator 304, a selector 306, and a generator 308. The optimizer 300 may be the optimizer 112 illustrated in FIG. 1 or the web server/optimizer 210 illustrated in FIG. 2. The evolutionary algorithm may consider each candidate configuration as a vector of the parameters that are optimized. The algorithm may include the components illustrated in the optimizer 300 of FIG. 3.

The initializer 302 initializes a candidate set of parameter vectors. As described, the parameter vector may include a configuration of multiple parameters that is to be optimized. Evolutionary algorithms may start with a random set of candidate parameter vectors. This set of candidate parameter vectors may be known as a population. In one embodiment, the initializer 302 may start with a random population for optimizing. Alternatively, the starting population may be based on a known set of parameters, such as a default configuration. For example, default parameter values may be used for an initial configuration before optimization.

The evaluator 304 is coupled with the initializer 302 and evaluates each candidate/configuration of parameters based on the objectives. For example, FIG. 4 illustrates that the objectives and parameters are inputs for the optimizer. The evaluator 304 evaluates a particular set of parameters (or a configuration) based on those objectives. In one embodiment, the evaluator 304 considers each of the objectives and determines how well each of the objectives is met by the configuration. The evaluator 304 uses the slice or subset of user queries that are assigned to a particular configuration to measure each of the objectives. For example, if one of the objectives is to maximize clicks on advertisements, the evaluator 304 may measure the click through rate on the advertisements displayed for the different slices of traffic corresponding to each candidate configuration. The evaluation of each configuration may require a minimum number of queries with which each configuration is evaluated. A small sample size may result in an incorrect evaluation of the objectives by the evaluator 304. The evaluation does not have to be completely accurate; rather, it may merely need to give direction to the algorithm on the parameters that should be changed for a revised configuration.

The selector 306 is coupled with the evaluator 304 and receives the evaluated candidates for selecting new candidates or configurations. The selector 306 may identify the best candidates based on one or several objectives. The selector 306 may select candidates according to each candidate's respective satisfaction of one or more objectives. There are various single-objective selection methods that may be utilized, and exemplary single-objective selection methods are described in “Genetic Algorithms in Search, Optimization, and Machine Learning” by David Goldberg (Addison-Wesley, 1989), the entire disclosure of which is incorporated by reference. Multi-objective selection may include sorting candidates according to a level of non-domination and using that level to bias selection for a subsequent iteration. Exemplary multi-objective selection methods are described in “Multi-Objective Optimization using Evolutionary Algorithms” by Kalyanmoy Deb (Wiley, 2009), the entire disclosure of which is incorporated by reference.

The generator 308 is coupled with the selector 306 and generates a new configuration of parameters for evaluation based on the selected parameters and/or configuration. The generator 308 may also be referred to as an iterator. There are multiple methods for creation of new candidates for optimization including several methods described in “Genetic Algorithms in Search, Optimization, and Machine Learning” by David Goldberg (Addison-Wesley, 1989) which was incorporated by reference herein. In one embodiment, the new configuration may be passed directly to the evaluator 304 for evaluation. As described, the initializer 302 may utilize a random or pseudo-random configuration for the first iteration, but on subsequent iterations, the configuration parameters are determined by the evaluation and selection.

The output of a multi-objective algorithm may be a set of parameter vectors that span the Pareto optimal front. In other words, multiple solutions may be available. Accordingly, in one embodiment, a human decision maker may receive the outputted configurations and accompanying sets of parameters and make a determination as to which configuration to use. The algorithm output may be a set of non-dominated solutions that are closer to a Pareto optimal front. The optimal front may represent a minimizing of objectives.

FIG. 4 is a diagram of exemplary optimization. The optimizer 400 receives objectives 402 and configuration parameters 404. FIG. 5 illustrates exemplary objectives 402 and FIG. 6 illustrates exemplary configuration parameters 404. The optimizer 400 analyzes the configuration parameters 404 in view of the objectives 402 to identify updated configuration parameters 406. The updated configuration parameters 406 are used as the next iteration of configuration parameters 404. The optimizer 400 iteratively identifies the configuration parameters that satisfy the objectives. Although not shown, the optimizer 400 may consider multiple configurations/configuration parameters 404 at any given time. The multiple configurations/configuration parameters 404 may be from multiple slices of user queries. Accordingly, the updated configuration parameters 406 may be a set of parameters corresponding with each set of input configuration parameters 404, or may be based on more than one set of input configuration parameters 404. The optimizer 400 is configured to simultaneously optimize different sets of configuration parameters 404, which may or may not be subject to the same objectives 402.

FIG. 5 is a diagram of exemplary objective categories for optimization. The objectives 402 include the goals of the optimization. As illustrated in FIG. 5, the objectives 402 include categories of objectives. The optimization may be designed to identify the configurations and adjust the configuration parameters 404 to satisfy the objectives 402. The optimization further includes changing the configuration parameters 404 to measure which configurations achieve the identified objectives 402.

The exemplary objective categories are user satisfaction 502, advertiser satisfaction 504, and revenue 506. There may be additional objectives that are not shown or described, but that relate to a particular goal of the optimization.

When the objective includes the user satisfaction 502, the configurations and configuration parameters are analyzed to present advertisements on a page that result positive user feedback. The user satisfaction 502 may be measured in a number of different ways. The user satisfaction with a page and/or with the ads on that page may be based on interaction of the user with that page and/or with the ads on that page. For example, the user satisfaction may be measured by a click through rate, conversions, or other metrics that measures the user's interaction with an advertisement. Other metrics include click yield, coverage, north ad impact, click delay, and/or dwell time. Click yield may refer to the number of clicks divided by the number of searches. North ad impact may be measured using editorial judgments of relevance of ads and web results and noting any degradation of relevance due to ads. Coverage may refer to the percentage of queries for which ads are shown. Click delay includes an amount of time that a user views a page before clicking on an ad.

The advertiser satisfaction 504 is another objective 402 for optimization. The advertiser satisfaction 504 may measure a perceived success of an advertisement on a page, such as a search results page. An exemplary metric for measuring the advertiser satisfaction 504 is the return on investment (“ROI”). The ROI includes a measurement of a profit of an advertisement, such as revenue generated from the ad minus the expense of displaying the ad.

The revenue 506 generated by an advertisement for a search engine may be another objective. The ROI discussed above was a form of revenue for the advertiser, but another type of objective is the revenue for the search engine. Certain ads may generate more revenue for the search engine depending on the configurations. A goal of the optimization may be to maximize the revenue of the search engine.

The objectives of the optimization may be subjective and may require editorial review as part of the optimization. Alternatively, the optimization may be automated and the objectives may be analyzed automatically without editorial review.

FIG. 6 is a diagram of exemplary configuration parameters 404. The configuration parameters 404 include any display features for an advertisement on a page, such as a search results page. The configuration parameters 404 may be adjustable and the optimization relates to optimizing the adjustments of the configuration parameters 404 to achieve the identified objectives. The ad server may provide a set of candidate advertisements for display on a page and the configuration parameters 404 may be used for the selection and display of ads on a particular page. The optimization may be used for identifying a better selection and/or better display of ads that achieve the objectives.

The ad placement 602 is an exemplary configuration parameter 404. In particular, ad placement 602 relates to the location on a page that an advertisement is displayed. The ad may appear at the top of the page, may appear on the side of the main content of the page, or may appear at the bottom or middle of a page. In a search results page, an ad may be displayed along with the search results. The placement of an ad may be used to improve various objectives such as conversions or click probability. For example, the real-time feedback with the optimization algorithm may determine that a video ad at the top of a page is less successful than just an image located at the top of the page. Accordingly, the optimization algorithm may result in future configurations with an image at the top of the page rather than a video as a way of meeting the objectives.

The ad selection 604 is another exemplary configuration parameter 404. The ad selection 604 may include whether the ad is an image, text, video, audio, flash, interactive (rich) media/standard media, or other multimedia. Different methods of selection may be utilized in different configurations. For example, ad selection may be based on rewriting the user query to find related queries, or may be based on matching the user query to the content of the ads. Different configurations may give preference to different ad selection methods. The ad ranking 606 includes an order in which an ad is shown. The ad ranking 606 may be related to the ad selection 604. When multiple ads are selected for display, those ads may be ranked for display on the page. The ranking may be based on relevance, or based on the price paid by each advertiser. In addition, the ad ranking 606 may also include the popularity, click history, the impression goal, the advertising budget, and/or how advertisement revenue is generated, such as cost per click (CPC) or cost per mille (CPM). The ad quality 606 may be a subjective measure of the quality of an advertisement. There may be a minimal threshold for quality of an ad. The quality may be based on subjective determinations, or may be based on a measure of popularity of the ad. The ad filtering 610 may include removing or selecting an advertisement based on a filtering by another condition. For example, the ads may be filtered based on quality, popularity, or relevance.

New advertisements may be subjected to a process of auditioning that includes displaying the advertisements in different positions on the page and/or to different users in order to collect performance metrics necessary to evaluate the quality of the advertisements. The auditioning process may be controlled by parameters for auditioning 612. The auditioning parameters 612 may include controls of how frequently the advertisements are displayed in different positions and for how long advertisements are subject to auditioning. The user data 614 may be targeted for particular ads. This parameter, like other parameters, is related to the ad selection 604 in the sense that different ads may be selected for different types of users. The user data 614 may include geography or demographic information that is targeted. Different configurations may refer to how much importance is given to the user data for targeting the advertisements. The user data 614 may further include explicit and/or implicit user preferences for tracking the advertising features to which each user may be more likely to respond. Tracking data may be a part of the user data. The tracking data may include the user interactions depending on the time of day, colors, shopping items, webpage content, and purchase data as they relate to advertisement interaction.

The user data 614 may include a compilation of user personal profile data received from accessible personal profiles of users that may click through an advertisement. For example, the number of women who click through a particular advertisement may be tracked and considered for the future display of that advertisement. In addition to gender, the user data may include average age, zip code, email address, occupation, income level, industry, ethnographic information, purchase history, and/or personal interests of users that click through a particular advertisement. This data may be used for optimizing between different configurations depending on the users of a particular configuration.

In a search results page, there may be additional parameters related to the search query. For example, result quality 616, result content 618 may be parameters that are different for different configurations. Exemplary configurations may include considerations of the search results, including the result quality and result content.

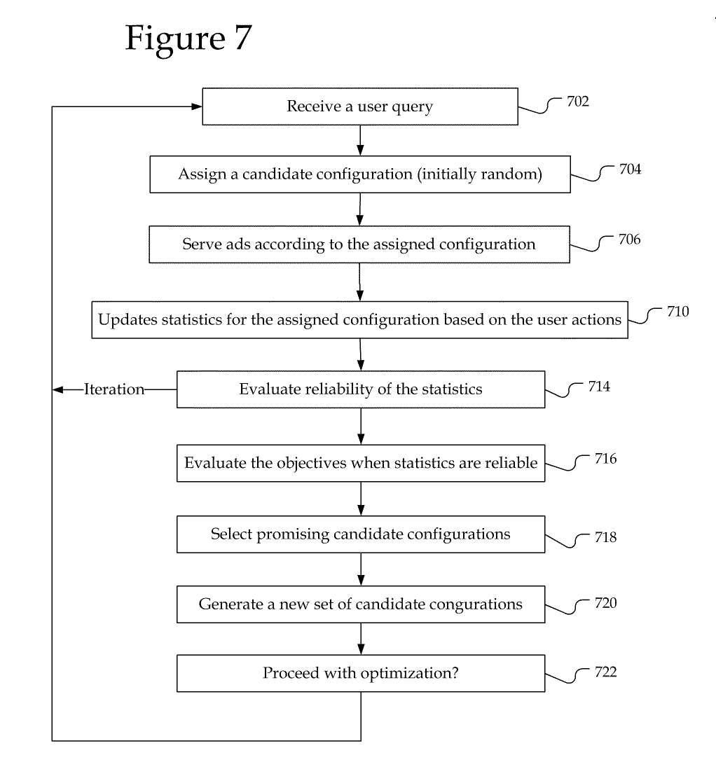

FIG. 7 is flowchart of exemplary optimization. The exemplary embodiment described in FIG. 7 relates to optimization of ads displayed on a search results page from a search engine. Alternatively, the optimization may be of other types of pages. In block 702, the search engine receives a user query. In response to receipt of the user query, the search engine analyzes the query and identifies search results for that query. In block 704, a candidate configuration is assigned randomly for that query. As described the configuration comprises any number of configuration parameters that establish a particular advertisement. In one example, the configuration may include the display of a banner animation that has the highest click yield. Alternatively, any of the configuration parameters 404 may establish a particular configuration of the search results page and the displayed ad(s) on that page. That configuration is initially set at random as in block 704 and the ad(s) are displayed according to the assigned configuration as in block 706.

Upon displaying the ad(s) according to a particular configuration, the user's actions may be monitored. The monitoring may be used for evaluating that particular configuration in real-time. For example, when a particular configuration is displayed to a set of users, the reactions by each of those users to that configuration is monitored and used for preparing the next configuration that is displayed and subsequently analyzed. In particular, the assigned configuration may have statistics that are updated for that configuration based on the user actions as in block 710. As described, for a particular configuration, metrics such as click through rate, click yield, coverage, click delay, click dwell time, and revenue may be collected based on user actions. The statistics that are updated may be iteratively gathered for different configurations based on the reliability evaluation in block 714.

The reliability of the metrics may be evaluated in block 714 for each particular configuration. The evaluation of the reliability may be based on statistical tests to confirm that enough user actions have been observed to reliably estimate the metrics. For example, in block 714 there may be a statistical test to determine if enough user queries have been observed to estimate the click through rate with a given confidence. If the statistical test indicates that additional queries are needed to estimate a given metric, the system may iterate to receive another user query. The objectives are evaluated when the reliability of the statistics is confirmed as in block 716. In block 718, after the configurations are evaluated, the promising candidate configurations are selected using single or multiple objective methods. Exemplary methods are described in the books by Goldberg and Deb cited above. Based on the selection of candidate configurations, a new set of candidate configurations is generated in block 720. The generation of new candidates may be based on exemplary candidate generation methods described in the book by Goldberg cited above. In block 722, the optimization process may proceed by iteratively considering additional candidate configurations to improve upon the selection of the promising candidate configurations.

The system and process described may be encoded in a signal bearing medium, a computer readable medium such as a memory, programmed within a device such as one or more integrated circuits, and one or more processors or processed by a controller or a computer. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

We claim:

1. A method for real-time feedback for sponsored search comprising:
determining a configuration for a first subset of received search queries;
monitoring the configuration by measuring a real-time response to displays of search results from the received search queries;
evaluating the configuration based on the real-time response, wherein the evaluating comprises a comparison with objectives;
modifying the configuration based on the evaluation; and
iteratively monitoring, evaluating, and further modifying the modified configuration until the iteratively modified configuration satisfies the objectives.

2. The method according to claim 1 wherein the configuration comprises a plurality of parameters that are each set to a particular value.

3. The method according to claim 2 wherein the parameters comprise at least one of advertisement placement, advertisement selection, advertisement ranking, advertisement quality, advertisement filtering, auditioning, user data, result quality, or result content.

4. The method according to claim 3 wherein the modifying the configuration based on the evaluation further comprises:
identifying parameters that match with the objectives based on the comparison; and
identifying parameters that did not match with the objectives based on the comparison.

5. The method according to claim 4 wherein the act of modifying the configuration comprises modifying those parameters that did not match with the objectives.

6. The method according to claim 1 wherein the objectives comprise user satisfaction, advertiser satisfaction, and revenue.

7. The method according to claim 6 wherein the comparison with the objectives further comprises compiling statistics regarding the real-time feedback with the displays of the search results.

8. The method according to claim 1 wherein the compiled statistics include a return on investment that results from a particular configuration, further wherein the return on investment matches with a revenue objective.

9. The method according to claim 1 wherein the displays of results comprises providing a search results page.

10. The method according to claim 9 wherein the search results page includes at least one advertisement, further wherein the monitoring and evaluating are based on the at least one advertisement.

11. The method according to claim 10 wherein the real-time response comprises an interaction with the at least one advertisement.

12. A computer system for optimizing advertising comprising:
a search engine processor configured to receive a search query and provide search results in response to the search query;
an advertisement server coupled with the search engine and configured to provide at least one advertisement with the search results; and
an optimizer coupled with the search engine and configured to optimize the at least one advertisement provided with the search results, the optimizer comprising:
an initializer that establishes an initial configuration for providing the at least one advertisement;
an evaluator that determines a success of the at least one advertisement, wherein the success is measured by a comparison with at least one objective to be optimized;
a selector that modifies the initial configuration to generate a modified configuration for providing the at least one advertisement; and
an iterator that repeats the evaluator and the selector with the modified configuration until the iteratively generated modified configuration results in a measured success that satisfies the at least one objective.

13. The system of claim 12 wherein the at least one objective comprises a revenue amount generated.

14. The system of claim 13 wherein the measured success satisfies the at least one objective when the revenue amount generated exceeds a predetermined minimum.

15. The system of claim 12 wherein the configurations comprise a plurality of parameters and the modification of a configuration comprises modifying at least one of the parameters.

16. In a computer readable medium having stored therein data representing instructions executable by a programmed processor for optimizing sponsored search results, the storage medium comprising instructions operative for:
assigning an initial configuration for responding to each of a plurality of search queries;
providing a search results page according to the initial configuration for each of the search queries;
monitoring a plurality of responses to the search results pages;
compiling tracking statistics for the initial configuration from the monitoring of the search results pages, wherein the tracking statistics comprise the responses from each of the search results pages;
generating a revised configuration based on the tracking statistics;
iteratively, repeating the providing, monitoring, and compiling steps with the revised configuration; and
comparing the tracking statistics for the revised configuration to determine when objectives for optimization are met by the revised configuration, wherein additional iterations are performed until the revised configuration meets the objectives for optimization.

17. The computer readable medium of claim 16 wherein the responses include a user interaction.

18. The computer readable medium of claim 17 wherein the search results page further include advertisements and the tracking statistics comprise interactions with the advertisements.

19. The computer readable medium of claim 16 wherein the objectives comprise at least one of user satisfaction, advertiser satisfaction, or return on investment.

20. The computer readable medium of claim 16 wherein the initial configuration and the revised configuration comprise adjustable parameters for the display of the search results page.

21. The computer readable medium of claim 20 wherein the generating of the revised configuration based on the tracking statistics comprises:
identifying which of the parameters meet the objectives;
identifying which of the parameters do not meet the objectives; and
modifying those parameters that do not meet the objectives, wherein the revised configuration comprises the parameters that meet the objectives and the modified parameters.
